(19) United States
(12) Patent Application Publication
(10) Pub. No.: US 2018/0075301 A1
(43) Pub. Date: Mar. 15, 2018

(54) PORTABLE COMPUTER APP PROVIDING DISTANCE MEASUREMENT

(71) Applicant: David Bradley Everhart, Bolivia, NC (US)

(72) Inventor: David Bradley Everhart, Bolivia, NC (US)

(21) Appl. No.: 15/263,468

(22) Filed: Sep. 13, 2016

(51) Int. Cl. G06K 9/00

(52) U.S. Cl. CPC G06K 9/00671; H04W 88/02

(57) ABSTRACT

The present invention relates to an app on a smartphone, or other portable computer, which can be used to control a camera, or other device, for measuring the distance between the smartphone and a desired object or location.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to distance measurement. In particular, it relates to use of a portable computer to provide the distance in-between two points.

### Description of Related Art

The need to measure the distance between two points has been necessary for centuries. Carpenters, builders, scientists, and the like have the need to make exact measurements. For decades, simple tape measures have been utilized by carpenters, inspectors, and people at home for such measurements. Over the last couple of decades, electronic laser measurement devices have been introduced, which increase accuracy.

While both types of devices work well, they can typically be forgotten or lost, especially if they aren't used daily. Even if these devices are used daily, they can break, leaving the person without a means to measure distance. Accordingly, there is a tremendous need to have a device which is almost always with the person and can be used as a backup in circumstances where standard devices for distance measuring become unavailable.

### BRIEF SUMMARY OF THE INVENTION

The present invention relates to an app designed for a portable computing device which can control the devices on the computing device, such as a camera or an additional measuring device, and provide distance measurements on the computing device.

Accordingly, in one embodiment, there is a non-transitory machine readable storage medium, having encoded thereon an app for a smartphone or other mobile computing device that, when executed, interacts with the smartphone or other mobile computing device's camera, or other distance measuring device, and causes the camera or other distance measuring device to:
a) actively measure distance to an object the camera or other distance measuring device is pointed at; and
b) actively report the distance measured to the app;

wherein the app reports the distance measurement to a graphic user interface on the smartphone or other mobile computing device.

In another embodiment, there is a smartphone or other mobile computing device implemented method of measuring the distance between the smartphone or other mobile computing device and a selected point in space, comprising executing the steps of:
a) engaging a non-transitory machine readable storage medium, having encoded thereon an app;
b) executing the app such that it interacts with the smartphone or other mobile computing device's camera or other distance measuring device and causes the camera or other distance measuring device to:
   i. actively measure distance to an object the camera or other distance measuring device is pointed at; and
   ii. actively report the distance measured to the app; and
c) engaging the app to actively report the distance to a graphic user interface on the smartphone or other mobile computing device.

### BRIEF DESCRIPTION OF THE DRAWINGS

FIG. 1 is a relationship graphic of the method of the present invention.

FIG. 2 is a flowchart graphic of the system of the present invention.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

References throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein, the term “non-transitory machine readable storage medium” refers to any storage device used for storing data accessible by a smartphone or computer of the present invention. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

As used herein the term “app” refers to application software downloaded to a mobile device of the present invention via the Internet. The computer software is designed to help the user perform specific tasks on or from their mobile device (i.e. control distance measurement).

As used herein, the term “smartphone or other mobile computing device” refers to one or more apparatus and/or one or more systems that are capable of accepting a structured input, processing the structured input according to prescribed rules, and producing results of the processing as output. Examples of a computer may include: a smartphone, a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with Internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units. “Software” may refer to prescribed rules to operate a computer. Examples of software may include: code segments in one or more computer-readable languages; graphical and or/textual instructions; applets; pre-compiled code; interpreted code; compiled code; and computer programs.

As used herein, the term “interacts” refers to giving or receiving digital instructions for operation or data transfer.

As used herein, the term “camera or other distance measuring device” refers to a device in or mounted to the smartphone (or other computing device) that can sense distances between the device and an object that it is pointed at. So, most smartphones now have cameras, which include autofocus, which has a system to send and receive data to where it is pointed at to use a mathematical formula to adjust the lens for proper focus. In other embodiments, a laser measurement tool can be installed and the app used to control the device, take measurements, and report to the user's graphic user interface on the smartphone.

As used herein, the term “actively measure distance” refers to activating the camera or other device to use the send/receive function to measure distance between the smartphone and an object the smartphone is pointed at.

As used herein, the term “pointed at” refers to the distance measuring device having a means of focus or picking where the measurement is going to/from, such as a laser light or a focus ring in the viewfinder of the camera. So, in practice, if one wanted to measure from the smartphone to a tree, the device would be pointed at the tree and the measurement taken.

As used herein, the term “actively report or reports” refers to the app collecting information from the camera, or other distance measuring device, and sending it to the graphic user interface of the smartphone, so that the measurement can be read by the user.

As used herein the term “database storage system for recording multiple measurements” refers to a system that manages storage, access, and update of data in a database that is made up of one or more relational tables.

In the practice of the invention, the app of the invention is engaged to interact with the measuring device, such as an internal smartphone camera. The user of the app points the smartphone's camera at the object position to be measured to and auto focus, or other measurement device, takes a measurement by bouncing a signal to and from the position. The app takes the information and calculates the exact measurement, which then is sent to the smartphone screen (GUI) as a read out. The measurement can be saved in a database for later use or deleted.

### DRAWINGS

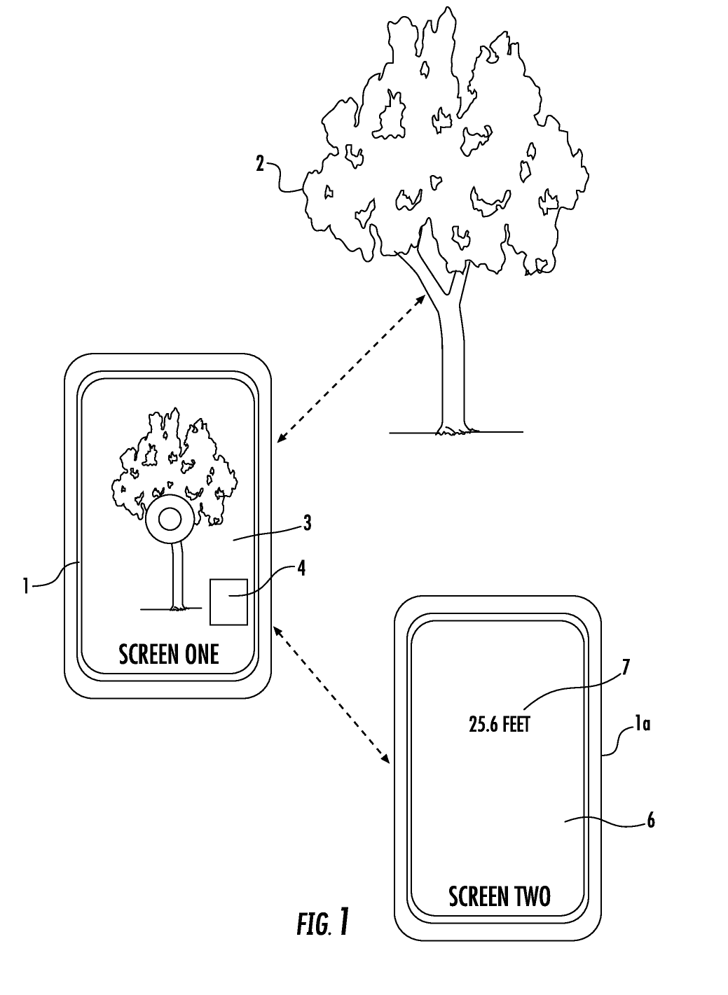

Now referring to the drawings, FIG. 1 is a relationship graphic of the app in use. Smartphone 1 uses its camera (not seen and on the opposing side of smartphone 1) to focus on tree 2. GUI screen one 3 shows the tree and an app button 4 to take the measurement. Pressing app button 4 causes the software to take the reading from the camera or other measurement device and convert it to a distance number. Upon calculation, the smartphone 1a changes to GUI screen two 6 which shows the measurement 7, in this case it is 25.6 feet from the smartphone 1 to the tree 2.

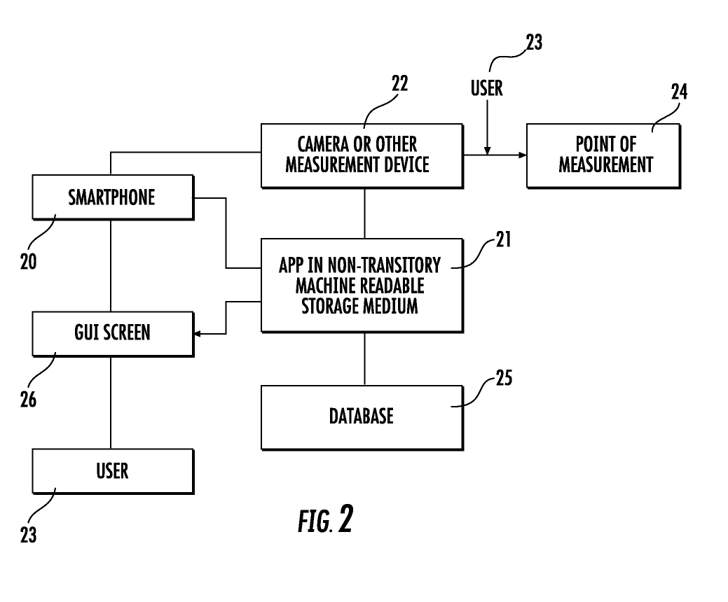

In FIG. 2 we have the system of the present invention, with smartphone 20 which has an app 21 in non-transitory machine recordable storage medium. The app 21 sends control information to the camera 22 or other distance measuring device which is pointed by user 23 at a point of measurement 24 and takes a distance reading. The information is delivered to the app 21 which delivers a copy of the measurement to the database 25 for storage and a copy to the smartphone's GUI screen 26 for the user 23 to read.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A non-transitory machine readable storage medium, having encoded thereon an app for a smartphone or other mobile computing device that, when executed, interacts with the smartphone or other mobile computer device's camera or other distance measuring device and causes the camera or other distance measuring device to:
a) actively measure distance to an object the camera or other distance measuring device is pointed at; and
b) actively report the distance measured to the app;
wherein the app reports the distance measurement to a graphic user interface on the smartphone or other mobile computing device.

2. The storage medium according to claim 1 which is operationally mounted on a smartphone.

3. The storage medium according to claim 1 which has a database storage system for recording multiple measurements.

4. The storage medium according to claim 1 wherein the other distance measuring device is a laser measuring device.

5. A smartphone or other mobile computing device implemented method of measuring the distance between the smartphone or other mobile computing device and a selected point in space comprising executing the steps of:
a) engaging a non-transitory machine readable storage medium, having encoded thereon an app;
b) executing the app such that it interacts with the smartphone or other mobile computing device's camera or other distance measuring device and causes the camera or other distance measuring device to:
i. actively measure distance to an object the camera or other distance measuring device is pointed at; and
ii. actively report the distance measured to the app;
c) engaging the app to actively report the distance to a graphic user interface on the smartphone or other mobile computing device.
